(19) United States
(12) Patent Application Publication
(10) Pub. No.: US 2016/0313717 A1
(43) Pub. Date: Oct. 27, 2016

(54) Field Device for Detecting or Monitoring a Physical or Chemical Process Variable of a Medium

(71) Applicant: Endress+Hauser GmbH+Co. KG, Maulburg (DE)

(72) Inventors: Klaus RUF, Rheinfelden (DE); Romuald GIRARDEY, Blotzheim (DE); Peter KLÖFER, Steinen (DE); Martin HORTENBACH, Linkenheim-Hockstetten (DE)

(21) Appl. No.: 15/103,043

(22) PCT Filed: Nov. 14, 2014
(86) PCT No.: PCT/EP2014/074619

§ 371 Date: Jun. 9, 2016

(30) Foreign Application Priority Data
Dec. 18, 2013 (DE) 10 2013 114 377.6

(51) Int. Cl. G05B 19/042

(52) U.S. Cl. CPC G05B 19/0428; G05B 2219/25428; G05B 2219/25462; G05B 2219/31121; G05B 2219/33204

(57) ABSTRACT

The invention relates to a field device for detecting or monitoring a physical or chemical process variable of a medium in automation technology, having a power output (6), which is arranged on the primary side (P), and having an electronics unit (3, 13) which is arranged on the secondary side (S) and is supplied with energy from the primary side (P) via two connecting lines (4), wherein the electronics unit (3) actuates the power output (6) such that the direct current flowing on the connecting lines (4) represents the value of the process variable which is detected on the secondary side (S), having at least one communications unit (7) which provides digital data (Data), and having a galvanically decoupled transmission means (9) which transmits the digital data (Data) between the primary side (P) and the secondary side (S), wherein a circuit arrangement having two switches of a primary-side switch pair (11) is provided, wherein one switch of the primary-side switch pair (11) is arranged in each connecting line (4), having two switches of at least one secondary-side switch pair (12), wherein one switch of the secondary-side switch pair (12) is arranged in each connecting line (4), having an intermediate energy storage means (18), which is arranged between the primary side (P) and the secondary side (S), and a secondary-side energy storage means (19) which is associated with the secondary side (S), wherein the two energy storage means (18, 19) are connected in parallel to one another, and having at lea one electronic control circuit (14) which alternately actuates the switch pairs (11, 12) such that the primary side (P) and the secondary side (S) are galvanically disconnected from one another.

The invention relates to a field device for detecting or monitoring a physical or chemical process variable of a medium in automation technology having a power output arranged on the primary side and an electronics unit arranged on the secondary side which is powered via two connecting lines from the primary side, wherein the electronic unit controls the power output so that the direct current flowing in the connecting lines represents the value of the process variable detected on the secondary side, with at least one communication unit providing the digital data, and with a galvanically decoupled transmission means that transfers the digital data between the primary side and the secondary side.

In automation technology, especially in process automation technology, field devices are used that serve to determine and monitor process variables. Examples of such field devices are fill level measuring devices, flow measuring devices, analytical measuring devices, pressure and temperature measuring devices, humidity and conductivity measuring devices, and density and viscosity measuring devices. The sensors in such field devices capture the relevant process variables, e.g., the fill level, flow, pH value, substance concentration, pressure, temperature, humidity, conductivity, density, or viscosity.

Under the term ‘field devices’ in connection with the invention, actuators, e.g., valves or pumps, are, however, also, subsumed, through which, for example, the flow of a liquid in a pipeline or the fill level in a container can be changed. The company group Endress+Hauser offers and distributes a large variety of such field devices.

The 4-20 mA standard is widely used in automation technology. Here, the direct current flowing in a line is adjusted so that, in each case, it represents the current value of the process variable. If it is a two-wire device, then the power supply and data transmission are carried out via the same two-wire line.

In order to prevent the transmission of line-bound electromagnetic interference between the primary side and the secondary side, the use of either a filter circuit or a galvanic disconnection is known from prior art.

Both known solutions have advantages as well as disadvantages. Thus, filter circuits have the advantage that they are inexpensive and easy to implement. However, it is difficult to almost impossible to realize good broadband suppression. To achieve broadband suppression, the filter function must be adapted to the system sensitivity, which in turn requires a complex development.

A galvanic disconnection, based upon, for example, transformers or transducers, is more complex to develop than a filter circuit, but does yield a good decoupling between the primary side and the secondary side in terms of line-bound electromagnetic interference. However, the decoupling is not perfect: Due to the design of a transformer/transducer, a capacitive coupling typically exists between the primary side and the secondary side. As a result of the capacitive coupling, electromagnetic interferences can be transferred from the primary side to the secondary side. In addition, the efficiency is usually a maximum of between 70% and 80%, which can be quite critical for two-wire devices that have limited energy available. Also, the transfer of static signals via a galvanic disconnection proves to be relatively complex.

The object of the invention is to propose a field device, wherein the decoupling between the primary side and the secondary side is improved with regard to line-bound electromagnetic interference. The improvement is based upon the galvanic disconnection using transformers or transducers. Both energy and data are transferred between the primary side and the secondary side.

The object is achieved in that a circuit arrangement is provided
with two switches of a primary-side switch pair, wherein a switch of the primary-side switch pair is arranged in each connecting line,
with two switches of at least a secondary-side switch pair, wherein a switch of the secondary-side switch pair is arranged in each connecting line,
with an intermediate energy storage means arranged between the primary side and the secondary side and a secondary-side energy storage means associated with the secondary side, wherein the two energy storage means are connected in parallel to each other and
with at least one electronic control circuit that alternately controls the switch pairs so that the primary side and secondary side are electrically disconnected from each other.

The basic idea of the invention is to permanently galvanically disconnect the secondary side from the primary side by means of a suitable timing control circuit of electromechanical or electronic switch pairs.

According to an advantageous embodiment, the field device according to the invention is configured as either a two-wire device—meaning that the power supply and communication occur via the same two-wire line—or the field device according to the invention, configured as a four-wire device, i.e., the power supply and the communication each occur via two separate connecting lines.

Furthermore, either the field device according to the invention may be a compact device in which the components of the primary side and the components of the secondary side are arranged in a housing or, alternatively, the field device according to the invention is a detached version of a field device. Here, a part of the components of the primary side is associated with a first housing, and the remaining part of the components of the primary side and the components of the secondary side are associated with a second housing. In the detached version, the two housings are arranged at a distance from each other and connected to each other via a connecting cable.

In a first advantageous embodiment of the field device according to the invention, the intermediate energy storage means between the primary-side switch pair and the secondary-side switch pair is arranged so as to be connected in parallel. A secondary-side energy storage means connected in parallel to the intermediate energy storage means is downstream from the secondary-side switch pair. The at least one control circuit alternately closes the switches of the primary-side switch pair and opens the switches of the secondary-side switch pair during a predetermined or variable first time interval. During a subsequent predetermined or variable second time interval, the switches of the secondary-side side switch pair are closed, and the switches of the primary-side switch pair are opened. The time intervals are allocated so that there is always sufficient energy available on the secondary side for operating the electronics unit. In particular, the time intervals are adapted to the capacity of the energy storage means.

According to an alternative embodiment of the field device according to the invention, two intermediate energy storage means connected in parallel are provided between the primary-side switch pair and the secondary-side switch pair. A secondary-side energy storage means connected in parallel to the two intermediate energy storage means is downstream from the secondary-side switch pair. The at least one control circuit alternately connects the second intermediate energy storage means to the power supply via the switches of the primary-side switch pair and the switch of the secondary side switch pair, and the first intermediate energy storage means to the secondary-side energy storage means via the switches of the secondary-side switch pair during a predetermined or variable first time interval; during a predetermined or variable second time interval, the second intermediate energy storage means is connected to the secondary-side energy storage means via the switches of the secondary-side switch pair, and the first intermediate energy storage means is connected to the power supply via the switches of the primary-side switch pair. In this embodiment, the electronic unit is permanently supplied with energy, but the transfer of line-bound electromagnetic interference between the primary side and the secondary side is permanently prevented.

In order, also, to achieve the galvanic disconnection in a detached version of the field device, on the primary side, a second primary-side switch pair with a switch in each of the two connecting lines and a second primary-side control circuit are provided. The primary-side is still associated with the switches of the primary-side switch pair and the primary-side control circuit. On the secondary side, the secondary-side switch pair is provided with a respective switch in each of the two connecting lines. The intermediate energy storage means is arranged so as to be connected in parallel between the primary-side switch pair and the secondary-side switch pair. The secondary-side energy storage means is arranged so as to be connected in parallel to the intermediate energy storage means. It is alternately switched back and forth between the two following operating states: The second primary-side control circuit closes the switches of the second primary-side switch pair during a first time interval, the first primary-side control circuit simultaneously closes the switches of the primary-side switch pair, and the secondary-side control circuit simultaneously opens the switches of the secondary-side switch pair. The second primary-side control circuit opens the switches of the second primary-side switch pair during a second time interval, the first primary-side control circuit simultaneously opens the switches of the primary-side switch pair, and the secondary-side control circuit simultaneously closes the switches of the secondary-side switch pair.

It is preferable that the energy storage means are capacitors or batteries. With the use of capacitors, the capacitance of the capacitors and/or the length of the predetermined time intervals is allocated so that the minimum energy required by the field device for operation is always available. The handling in the case of batteries is analog.

According to an advantageous development of the field device according to the invention, the switches of the switch pairs are capacitively decoupled switches. In this case, a capacitively decoupled switch consists of two switches connected in series and a third switch connected in parallel. The connecting line of the two switches is connected to ground through the third switch in the open state of the capacitively-decoupled switch. Either relays or transistors are used as switches.

The galvanically disconnected transmission means are optical transmission links (optical fiber cable or optical coupler), and capacitive or radio transmission links.

The invention is explained in more detail by means of the following figures. Illustrated are

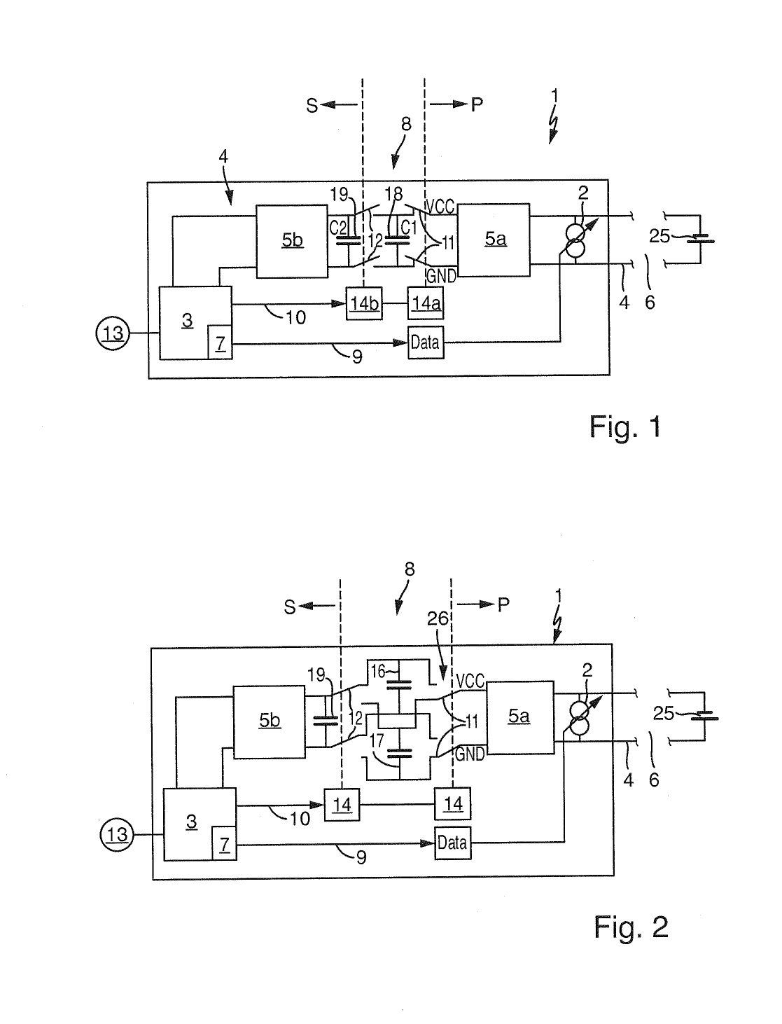

FIG. 1: a block diagram showing a first embodiment of the inventive field device in a compact version,

FIG. 2: a block diagram showing a second embodiment of the inventive field device in a compact version,

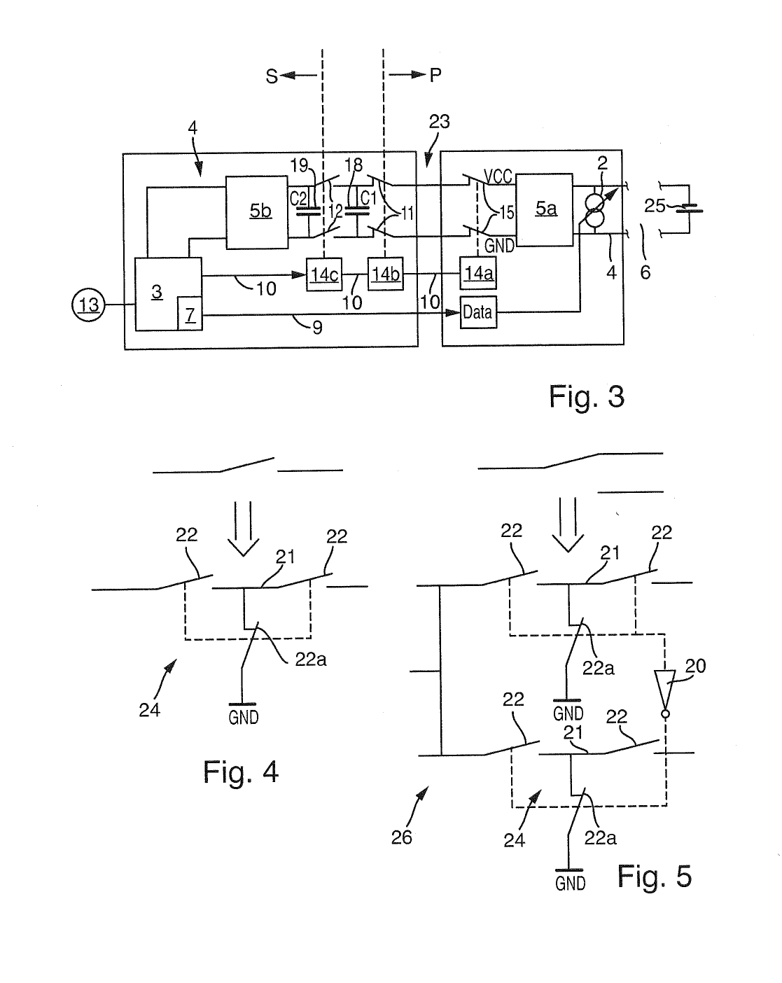

FIG. 3: a block diagram showing an embodiment of the inventive field device in the detached version,

FIG. 4: a block diagram of a preferred embodiment of the switches shown in the previous figures, and

FIG. 5: a block diagram of a preferred embodiment of the switch combination shown in FIG. 2.

FIG. 1 shows a block diagram illustrating a first embodiment of the inventive field device in a compact version. The field device according to the invention is preferably used for detecting or monitoring a physical or chemical process variable of a medium in automation technology, Examples of field devices and process variables have already been mentioned in the introduction.

On the primary side P, a power output 6 is arranged, while the electronic unit 3 is located on the secondary side S. The electronic unit 3 is associated with a sensor 13. In the case shown, the electronic unit 3 on the secondary side S is supplied with energy by a two-wire line 4 from the primary side P. The energy is provided by a remotely arranged voltage source 25. The voltage regulators 5a, 5b are used for transformation of the voltage from the voltage source 25 to the voltage required for operation by the electronic unit 3. In the case shown, the voltage regulator 5a is configured on the primary side P as a boost converter, while the voltage regulator 5b on the secondary side S is a buck converter.

The electronic unit 3 controls the power output 6 so that the direct current flowing in the two-wire line 4 represents the value of the process variable detected on the secondary side S. Further, a communication unit 7 is arranged on the secondary side S, which provides the digital data Data, and transmits it via the connecting line 9 to the primary side P. The connecting line 9 is a galvanically decoupled transmission means. Examples of suitable transmission means have been mentioned previously. It goes without saying that the communication may also take place from the primary side P to the secondary side S. The digital data can be, for example, calibration data, parametric data, or status information. In the illustrated case of a two-wire device, this communication data is modulated to the DC signal that reflects the value of the process variable.

In the embodiment shown in FIG. 1, two switch pairs 11, 12, which are suitably switched via two control circuits 14, are used for the galvanic disconnection 8 between the primary side P and the secondary side S. Switch pair 11 is arranged on the primary side P. In each case, one of the two switches of the switch pair 11 is arranged in one of the two connecting lines of the two-wire line 4.

Switch pair 12 is arranged on the secondary side S. In each case, one of the two switches of the switch pair 12 is likewise arranged in one of the two connecting lines of the two-wire line 4. In each case, one switch of the switch pair 11 is thus connected in series with a switch of the switch pair 12 in each connecting line of the two-wire line 4. The switches of the switch pair 11 on the primary side P are controlled by the control circuit 14a, while the switches of the switch pair 12 on the secondary side S are controlled by the control circuit 14b. The synchronization of the two control circuits 14a, 14b is done by the electronic unit 3 via the transmission line 10.

Between the two switch pairs 11, 12, which are provided on the primary side P and the secondary side 5, an intermediate energy storage means—here, the capacitor 18 with the capacitance C1—is connected in parallel. Another energy storage means—here, the capacitor 19 with the capacitance C2—is located behind the switch pair 12 on the secondary side S. The intermediate energy storage means 18 and the energy storage means 19 on the secondary side S are connected in parallel. The circuit arrangement shown allows for continuously operating the electronic unit 3 on the secondary side S, and yet permanently decoupling the primary side P from the secondary side S. Thus, the switches of the switch pairs 11, 12 must be suitably controlled.

Control of the switch pairs 11, 12 via the control circuits 14a, 14b is described below: During a first time interval, the switches of the switch pair 11 are closing, and the intermediate energy storage means 18 is charging. Simultaneously, the switches of the switch pair 12 are open.

During a subsequent second time interval, the switches of the switch pair 11 are opening, and, simultaneously, the switches of the switch pair 12 are closing. As a result of this switch sequence, the charge is transmitted from the intermediate energy storage means or from the capacitor 18 to the capacitor 19, which is arranged on the secondary side S. Subsequently, the switches of the switch pair 12 are opening again during the first time interval, and the switches of the switch pair 11 are closing. During the charging phase of the capacitor 18, the electronic unit 3 on the secondary side S is supplied with energy by the capacitor 19. Subsequently, the switching of the circuit arrangement according to the second time interval previously set forth is repeated.

In the solution shown in FIG. 2, two intermediate energy storage means or two capacitors 16, 17 are connected in parallel between the switch pairs 11, 12 on the primary side P and the secondary side S. A secondary-side energy storage means 19 is further connected in parallel to the two intermediate energy storage means 16, 17 downstream from the secondary-side switch pair 12. A control circuit 14 is associated with the switch pairs 11, 12, respectively. The two control circuits 14 are synchronized to alternately switch between two defined switching states in a first time interval and in a second time interval.

During the switching state in the first predetermined or variable time interval, the second intermediate energy storage means 17 is connected with the energy or voltage supply 25 via the operation of the switches of the primary side switch pair 11, and the first intermediate energy storage means 16 is connected with the secondary-side energy storage means 19 via the operation of the switches of the secondary-side switch pair 12. During the switching state in the second predetermined or variable time interval, the second intermediate energy storage means 17 is connected with the secondary-side energy storage means 19 via the operation of the switches of the secondary-side switch pair 12, and the first intermediate energy storage means 16 is connected with the power supply 25 via the operation of the switches of the primary-side switch pair 11. Also, in this embodiment, there is at no time an electrical connection between the primary side P and the secondary side S. The power supply occurs either via the intermediate energy storage means 16 or via the intermediate energy storage means 17. The capacity of the energy storage means 19 can be dimensioned small, since it must no longer be designed for the power supply during the second period, but serves only as a “bypass capacitor” during switching between the two intermediate energy storage means 16, 17.

In FIG. 3, an embodiment of the field device according to the invention for a detached version of the field device analogous to the compact version in FIG. 1 is shown. Here, a second primary-side switch pair 15 each having a switch in each of the two connecting lines of the two-wire line 4 and a second primary-side control circuit 14a are provided on the primary side P. The primary-side P is still associated with the switches of the primary-side switch pair 11 and the primary-side control circuit 14b. The secondary-side switch pair 12 each having a switch in each of the two connecting lines of the two-wire line 4 and the secondary-side control circuit 14c are located on the secondary side S. The intermediate energy storage means 18 is arranged connected in parallel between the primary-side switch pair 11 and the secondary-side switch pair 12. The secondary-side energy storage means 19 is arranged connected in parallel to the intermediate energy storage means 18.

Again, two different switching states are alternately controlled during a first time interval and a second time interval.

The second primary-side control circuit 14a closes the switches of the second primary-side switch pair 15 during the first time interval, and the first primary-side control circuit 14b closes the switches of the primary-side switch pair 11, while the secondary-side control circuit 14c simultaneously opens the switches of the secondary-side switch pair 12. The second primary-side control circuit 14a opens the switches of the second primary-side switch pair 15 during the second time interval, and the first primary-side control circuit 14b opens the switches of the primary-side switch pair 11. The secondary-side control circuit 14c simultaneously closes the switches of the secondary-side switch pair 12.

In FIG. 4, a block diagram of one of the switches of the switch pairs 11, 12, 15, shown in the previous figures, is illustrated. The preferred embodiment prevents a capacitive coupling in the switches of the switch pairs 11, 12, 15. The preferably used switches of the switch pairs 11, 12, 15 in connection with the invention are capacitively decoupled switches 24. For a capacitively decoupled switch 24, the center M is connected to ground GND in the off state. Via this connection, any line-related failures are dissipated to ground GND. All switches of the switch pairs 11, 12, 15—whether they are designed simply or optimally—can be implemented with relays or transistors.

FIG. 5 shows a block diagram of a preferred embodiment of the switch combination 26 shown in FIG. 2. In FIG. 5, the switch combination 26 is made from two capacitively decoupled switches 24. If one of the two switches 24 is open, the other switch 24 is closed. In order to implement the switching behavior of both switches 24, an inverter 27 is provided.

### LIST OF REFERENCE NUMBERS

1 Field unit
2 Power output control
3 Electronic unit
4 Two-wire line
5 Voltage regulator
6 Power output
7 Communication unit
8 Galvanic disconnection
9 Transmission means
10 Transmission means
11 Switch pair (primary side)
12 Switch pair (secondary side)
13 Sensor
14 Control circuit
15 Second switch pair (primary side)
16 Intermediate energy storage means
17 Intermediate energy storage means
18 Intermediate energy storage means
19 Energy storage means
20 Inverter
21 Connecting line
22 Switch
23 Connecting cable
24 Capacitively decoupled switch
25 Power supply voltage supply
26 Switch combination

1. Field device for detecting or monitoring a physical or chemical process variable of a medium in automation technology with a power output (6) arranged on the primary side (P) and an electronics unit (3, 13) arranged on the secondary side (S) that is supplied with energy from the primary side (P) via two connecting lines (4), wherein the electronic unit (3) controls the power output (6) so that the direct current flowing in the connecting lines (4) represents the value of the process variable detected on the secondary side (S), with at least one communication unit (7) that provides digital data (Data), and with galvanically decoupled transmission means (9) that transmits the digital data (Data) between the primary side (P) and the secondary side (S), wherein a circuit arrangement is provided with two switches of a primary-side switch pair (11), wherein, in each connecting line (4), a switch of the primary-side switch pair (11) is arranged, with two switches of at least one secondary-side switch pair (12), wherein, in each connecting line (4), a switch of the secondary side switch pair (12) is arranged, with an intermediate energy storage means (18) arranged between the primary side (P) and the secondary side (S) and a secondary-side energy storage means (19) associated with the secondary side (S), wherein the two energy storage means (18, 19) are connected in parallel to each other and with at least one electronic control circuit (14) that alternately controls the switch pairs (11, 12), so that the primary side (P) and the secondary side (S) are galvanically disconnected from each other.

2. Field device according to claim 1, wherein the field device is designed as a two-wire device, so that the power supply and the communication occur via the same connecting lines (4), or wherein the field device is designed as a four-wire device, whereby the power supply and the communication occur via separate connecting lines.

3. Field device according to claim 1, wherein the components of the primary side (P) and the components of the secondary side (S) are arranged in a housing.

4. Field device according to claim 1, wherein a portion of the components of the primary side (P) are associated with a first housing, wherein the rest of the components of the primary side (P) and the components of the secondary side (S) are associated with a second housing, and wherein the two housings are arranged separate from each other and are connected via a connecting cable (23).

5. Field device according to claim 1, wherein the intermediate energy storage means (18) is arranged connected in parallel between the primary-side switch pair (11) and the secondary-side switch pair (12), wherein a secondary-side energy storage means (19) is connected in parallel to the intermediate energy storage means (18) downstream from the secondary-side switch pair (12), and wherein the at least one control circuit (14) alternately closes the switch of the primary-side switch pair (11) and opens the switch of the secondary side switch pair (12) during a predetermined or variable first time interval, and closes the switch of the secondary side switch pair (12) and opens the switch of the primary-side switch pair (11) during a predetermined or variable second time interval.

6. Field device according to claim 1, wherein two intermediate energy storage means (16, 17) are provided between the primary-side switch pair (11) and the secondary-side switch pair (12) connected in parallel, wherein a secondary-side energy storage means (19) is connected in parallel to both intermediate energy storage means (16, 17) downstream from the secondary-side switch pair (12) wherein the at least one control circuit (14) alternately connects the second intermediate energy storage means (17) to the power supply (25) via the switches of the primary-side switch pair (11) and the first intermediate energy storage means (16) to the secondary-side energy storage means (19) via the switches of the secondary-side switch pair (12) during a predetermined or variable first time interval, and during a predetermined or variable second time interval, connects the second intermediate energy storage means (17) to the secondary-side energy storage means (19) via the switches of the secondary-side switch pair (12) and connects the first intermediate energy storage means (16) to the power supply (25) via the switches of the primary-side switch pair (11).

7. Device according to claim 1, wherein a second primary-side switch pair (15) each having a switch in each of the two connecting lines (4) and a second primary-side control circuit (14a) are provided on the primary side (P), wherein the primary side (P) is associated with the switches of the primary-side switch pair (11) and the primary-side control circuit (14b), wherein the secondary-side switch pair (12) is provided with a switch in each of the two connecting lines (4), respectively, on the secondary side (S), wherein the intermediate energy storage means (18) is arranged connected in parallel between the primary-side switch pair (11) and the secondary-side switch pair (12), wherein the secondary-side energy storage means (19) is arranged connected in parallel to the intermediate energy storage means (18), wherein, during a first time interval, the second primary-side control circuit (14a) alternately closes the switches of the second primary-side switch pair (15), and the first primary-side control circuit (14b) simultaneously closes the switches of the primary-side switch pair (11), and the secondary-side control circuit (14c) simultaneously opens the switches of the secondary-side switch pair (12), and wherein, during a second time interval, the second primary-side control circuit (14a) opens the switches of the second primary-side switch pair (15), the first primary-side control circuit (14b) simultaneously opens the switches of the primary-side switch pair (11), and the secondary-side control circuit (14c) simultaneously closes the switches of the secondary-side switch pair (12).

8. Field device according to claim 1, wherein the energy storage means (16, 17, 18, 19) are capacitors or batteries.

9. Field device according to claim 8, wherein the capacitance of the capacitors and/or the length of the predetermined time intervals is dimensioned so that the minimum energy required by the field device for operation is always available.

10. Field device according to claim 8, wherein the switches of the switch pairs (11, 12, 15) preferably are capacitively decoupled switches.

11. Field device according to claim 10, wherein the capacitively decoupled switch (24) consists of two switches (22) connected in series and a third switch (22a) connected in parallel, wherein the connecting line (21) of the two switches (22) in the open state of the capacitively decoupled switch (24) is connected to ground via the third switch (22a).

12. Apparatus according to claim 1, wherein the galvanically disconnected transmission means (9, 10) are optical, capacitive, or radio transmission links.

13. Device according to claim 1, wherein the switches of the switch pairs (11, 12, 15) are relays or transistors.
